(19) United States
(12) Patent Application Publication
(10) Pub. No.: US 2024/0286128 A1
(43) Pub. Date: Aug. 29, 2024

(54) KIT FOR FORMING A MICROPLATE ASSEMBLY FOR ABSORBANCE MEASUREMENTS OF LIQUID SAMPLES

(71) Applicant: Hoffmann-La Roche Inc., Little Falls, NJ (US)

(72) Inventor: Sven Matthias AMRHEIN, Basel (CH)

(21) Appl. No.: 18/693,273

(22) PCT Filed: Sep. 19, 2022
(86) PCT No.: PCT/EP2022/075949

§ 371 Date: Mar. 19, 2024

(30) Foreign Application Priority Data
Sep. 20, 2021 (EP) 21197823.4

(51) Int. Cl. B01L 3/00

(52) U.S. Cl. CPC B01L 3/5023; B01L 3/50255; B01L 2200/12; B01L 2300/0681; B01L 2300/069; B01L 2300/0893

(57) ABSTRACT

A kit for forming a microplate assembly for absorbance measurements of liquid samples comprises an upper plate (1) comprising at least one plurality of rods (12), each rod (12) having a flat rod bottom surface (121), a lower plate (2), and alignment guides for aligning the upper plate (1) and the lower plate (2) relative to each other as well as spacers for determining the distance of the upper plate (1) and the lower plate (2) relative to each other. The lower plate (2) comprises a plurality of wells (22), each having a flat well bottom surface (221). The alignment guides are configured and arranged such that each well (22) accommodates one rod (12) of each plurality of rods. The spacers comprise a plurality of threaded adjustment bolts (13a, 13b, 13c) which are arranged such that, when the upper plate (1) and the lower plate (2) are assembled to form the microplate assembly, each flat rod bottom surface (121) is arranged parallel to the corresponding flat well bottom surface (221) at a predetermined distance (43) in the range of 0.5 mm to 5 mm.

### FIELD OF THE INVENTION

The invention generally relates to the field of absorbance measurements. More specifically, it is related to a kit for forming a microplate assembly for absorbance measurements of liquid samples.

### BACKGROUND OF THE INVENTION

A broad range of applications in life sciences include spectrometric absorbance measurements of liquid samples such as DNA, RNA and proteins in solution. Typically, the concentration of one component of a liquid sample or a ratio of concentrations of several components of the liquid sample is either unknown or needs to be verified, and may be determined from such absorbance measurements. The determination of the concentration may form part of the quality control or the process control.

Within the applicable range of the Beer-Lambert law, the concentration of a single attenuating component in the liquid sample can be determined in case the optical path length is precisely known by the linear relationship between the absorbance and the concentration from the equation:

$$A = ε \cdot c \cdot L$$

in which
A is the absorbance,
L is the optical path length,
ε is the molar absorption coefficient, and
c is the concentration of the single attenuating component in the liquid sample.

In a number of applications, especially in pharmaceutical early research and development, the available amount of liquid sample is highly limited and the measurement needs to be performed with a minimal volume of the liquid sample in the μl (microliters) or ml (milliliters)-range. At the same time, it is required to be able to handle a large number of liquid samples. Thus, miniaturized and automated solutions using microplates in a standardized format (ANSI SLAS, formerly known as ANSI SBS) are the technology of choice. Spectrometric absorbance measurements are typically performed using microplates with 96, 384 or 1536 wells. To perform the automated absorbance measurements, a predetermined volume of the liquid sample is pipetted into the wells and the absorbance is measured using an automated plate-reader.

For the conventional design of standard microplates with open wells, there are several factors that may lead to inaccuracies of the optical path length, in particular in case of small volumes of the liquid sample. For example, deviations of the actual volume of the liquid sample from the desired volume of the liquid sample caused by inaccurate pipetting or by evaporation of the liquid sample during the time between pipetting the sample into the wells and performing the measurements may lead to deviations of the actual filling level in the respective well from the desired filling level, and thus to deviations of the optical path length from the optical path length used in the calculation for determining the concentration. Furthermore, the formation of a meniscus may lead to a non-uniform optical path length across the liquid-air interface and a significant deviation from the theoretically assumed optical path length.

U.S. Pat. No. 8,605,279 B2 (corresponding to US 2009/008168) discloses a microcuvette assembly, in which the liquid sample is held in place between two flat surfaces arranged on an upper and a lower plate of the microcuvette assembly, but does not disclose wells. Instead, the flat surfaces between which the liquid sample is held protrude towards each other from the upper and the lower plate, respectively. This assembly requires a very high degree of accuracy in pipetting as regards both the positioning of the pipettes as well as the pipetted volume of the liquid sample. In addition, the distance between the flat surfaces needs to be adapted to the volume and the surface tension of the liquid sample. Also, the liquid sample pipetted onto the flat surface of the lower plate is sensitive to mechanical influences such as shaking or rapid movement of the lower plate prior to formation of the microcuvette assembly by placing the upper plate on the lower plate. This may complicate a fully automated and efficient handling of the plates of the microcuvette assembly using standard microplate handling equipment, even if the layout and the dimensions of the microcuvette assembly may be similar to those of a standard microplate. Furthermore, during the time between pipetting the liquid samples onto the flat surfaces of the lower plate and the formation of the microcuvette assembly with the corresponding flat surfaces of the upper plate, the fully exposed liquid sample may at least partially evaporate. And even after formation of the (closed) microcuvette assembly with the liquid sample volume held between the two corresponding flat surfaces of the upper plate and the lower plate, the liquid sample may still partially evaporate via the uncovered sides.

It is therefore an object of the invention to overcome the afore-mentioned disadvantages.

### SUMMARY OF THE INVENTION

In accordance with the present invention, these and other objects are met by a kit for forming a microplate assembly and by a microplate assembly as they are specified by the features of the independent claims. Advantageous aspects of the kit according to the invention are the subject of the dependent claims.

As used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the “about” is included and explicitly disclosed, unless the context clearly dictates otherwise. For example, if a range of “about” numerical value A to “about” numerical value B is disclosed, this is to be understood to include and explicitly disclose a range of numerical value A to numerical value B. Also, whenever features are combined with the term “or”, the term “or” is to be understood to also include “and” unless it is evident from the specification that the term “or” must be understood as being exclusive.

According to the invention, a kit for forming a microplate assembly for absorbance measurements of liquid samples is suggested. The kit comprises:
an upper plate comprising at least one plurality of downwardly protruding rods made of glass and arranged in a rod pattern, each of the rods comprising a flat rod bottom surface facing downwards and a lateral outer rod surface extending upwards from a perimeter of the flat rod bottom surface, wherein the flat rod bottom surfaces of all rods of a same individual plurality of rods are arranged in a respective common first plane, and wherein each individual plurality of rods comprises the same number of rods and is arranged in the same rod pattern,
a lower plate,
alignment guides for aligning the upper plate and the lower plate relative to each other upon assembling the upper plate and the lower plate to form the microplate assembly, and
spacers for determining the distance of the upper plate and the lower plate relative to each other upon assembling the upper plate and the lower plate to form the microplate assembly.

The lower plate comprises a plurality of wells made of glass. The number of wells of the plurality of wells corresponds to the number of rods of each individual plurality of rods and the wells are arranged in a well pattern corresponding to the rod pattern.

The term ‘well’ as used herein denotes a hole or opening with a bottom, or a pit, or a similar compartment that is recessed relative to the surface of the plate in which the well is formed, and in the use position extends downwardly from the surface of the plate. The well comprises a lateral wall typically extending from the bottom of the well to the upper end of the well which typically is the plane of the surface of the plate in which the well is formed. Thus, the well is configured to contain a liquid in a manner such that the liquid cannot easily escape from or be dislocated in the well.

Each of the wells comprises a flat well bottom surface facing upwards and having an area in the range of 0.7 mm² to 29 mm². The flat well bottom surfaces of all wells are arranged in a common second plane.

Each of the wells further comprises a lateral inner well surface extending upwards from a perimeter of the flat well bottom surface. The lateral inner well surface is dimensioned to surround the lateral outer rod surface when the upper plate and the lower plate are assembled to form the microplate assembly. The alignment guides are configured and arranged such that when the upper plate is assembled with the lower plate to form the microplate assembly, the alignment guides engage one another to align the upper plate and the lower plate such that each well of the plurality of wells accommodates one rod of each individual plurality of rods.

The spacers comprise a plurality of threaded adjustment bolts.

Each threaded adjustment bolt of the plurality of threaded adjustment bolts is arranged in a threaded through-hole of the upper plate or the lower plate, with one end of the respective threaded adjustment bolt protruding from the upper plate or the lower plate, respectively, such that when the upper plate is assembled with the lower plate to form the microplate assembly, the one end of the respective threaded adjustment bolt abuts against the lower plate or the upper plate, respectively, and the flat rod bottom surface of each rod of each individual plurality of rods is arranged parallel to the corresponding flat well bottom surface and faces the flat well bottom surface at a predetermined distance in the range of 0.05 mm to 5 mm, in particular 0.1 mm to 2 mm, especially 0.2 mm to 1 mm.

The kit according to the invention offers the possibility to perform (spectrometric) absorbance measurements at a fixed optical path length of a light beam through the sample without compromising the advantages of conventional microplates with wells.

In contrast to the assembly disclosed in U.S. Pat. No. 8,605,279 B2 in which the protruding surfaces are the designated area for depositing the liquid sample, the lateral inner well surface of the respective well of the lower plate prevents the liquid sample from being dislocated due to the liquid sample being securely contained in its designated well. Even in case of movements of the lower plate or of the microplate assembly due to vibrations or shaking that might occur for example upon assembling of the upper plate and the lower plate to form the microplate assembly or during transfer of the microplate assembly to the plate reader or spectrometer, the liquid sample remains securely contained in the respective well. Furthermore, the kit according to the invention is suitable for any kind of liquid sample regardless of any sample-dependent properties related to adhesive and cohesive forces and surface tension.

Each rod protruding downwardly from the upper plate is arranged such that when the upper plate is assembled with the lower plate to form the microplate assembly, the alignment guides engage one another to align the upper plate and the lower plate such that the respective rod is accommodated by its corresponding well (due to the rod pattern corresponding to the well pattern). The flat well bottom surfaces and the flat rod bottom surfaces of all rods and wells of the microplate assembly are arranged parallel and facing each other at a predetermined distance. This is achieved with the aid of the threaded adjustment bolts, as will be explained in more detail below. The liquid sample dispensed into the plurality of wells of the lower plate wets the flat well bottom surface of the respective well at least partially and fills the entire space between the flat rod bottom surface and the flat well bottom surface. For cases in which the volume of the liquid sample may be affected by evaporation, evaporation is either prevented or at least greatly reduced as the liquid sample is enclosed by the flat rod bottom surface, the well bottom surface and the lateral inner well surface, thus greatly reducing the exposure of the liquid sample to air. The effect of possible evaporation of the liquid sample on the absorbance measurement can be further reduced by dispensing more sample liquid into the well than the minimum volume of liquid sample required to fill the entire space between the flat rod bottom surface and the flat well bottom surface. The additional amount of liquid sample does not affect the optical path length as it is displaced laterally into a space of the well which is not covered by the rod bottom surface, so that the impact of evaporation on the (spectrometric) absorbance measurements can be further reduced.

The kit according to the invention is relatively insensitive to variations of the pipetted volume of the liquid sample. In case the volume of the liquid sample actually dispensed into the wells deviates from the targeted volume of the liquid sample to be dispensed into the wells, the optical path length is not affected. For example, when the disposed liquid sample volume exceeds the targeted volume of the liquid sample, the desired optical path length is nevertheless determined by the distance between the rod bottom surface and the well bottom surface since any excess sample liquid is displaced by the rods. Thus, by increasing the targeted volume of the liquid sample to be dispensed into the wells to a volume slightly exceeding the minimum volume required to fill the entire space between the rod bottom surface and the well bottom surface, minor variations of the pipetted volume (possibly caused by the pipetting apparatus) do not have any effect on the absorbance measurement.

The threaded adjustment bolts are arranged in the threaded through-holes of the upper plate or the lower plate with one end protruding and abutting against the respective opposite plate when the upper plate and the lower plate are assembled to form the microplate assembly. Thus, they allow for adjustment of the distance between the plates at different positions of the respective plate. As the rods and the wells are rigidly connected to the respective plate such that the flat rod bottom surfaces are arranged in a common first plane and the well bottom surface are arranged in a common second plane, the adjustment bolts can be arranged and adjusted to ensure that the flat rod bottom surfaces of all individual rods are arranged parallel and at a predetermined distance from the individual well bottom surfaces such that the optical path length between the respective flat rod bottom surface and the corresponding flat well bottom surface is the same for all rods and wells.

As the optical path length is determined by the adjustable distance between the flat rod bottom surfaces and the flat well bottom surfaces, the optical path length can be chosen sufficiently small such that even liquid samples with a very high absorbance can be used for absorbance measurements without any dilution of the liquid sample being necessary. The optical path length can be chosen largely independent from the sample volume.

As is explained in more detail below, the upper plate may comprise only one plurality of rods or may comprise two or more pluralities of downwardly protruding rods.

The outer dimensions of the lower plate and the upper plate can easily be adapted to standard dimensions according to the ANSI SLAS standards for microplates (in particular ANSI SLAS 1-2004 (R2012) for microplates), in which case the kit according to the invention offers the possibility to perform automated measurements using standard equipment, i.e. standard liquid handling equipment (e.g. standard multi-channel pipettes), standard plate handling equipment, and standard plate readers.

According to one aspect of the kit according to the invention, the upper plate comprises only one plurality of downwardly protruding rods.

This aspect allows for an easy (spectrometric) measurement of the absorbance at a single optical path length and with a minimal volume of liquid sample. It even allows for measurements of volumes of the liquid sample which are so small that the liquid sample dispensed into the well only forms a drop on the flat well bottom surface. Modern liquid handling equipment is capable of dispensing a drop of the liquid sample at the center of the well, so that at the time the upper plate is assembled with the lower plate the drop fills a microcuvette defined by the respective flat rod bottom surface and the respective flat well bottom surface.

According to another aspect of the kit according to the invention, the upper plate comprises two or more pluralities of downwardly protruding rods, in particular four pluralities of downwardly protruding rods, and wherein all rods of the same individual plurality of rods have the same length. For example, in the case of four pluralities the flat rod bottom surfaces of all individual rods of the first plurality of rods are arranged in a first common plane for this first plurality of rods, whereas the flat rod bottom surfaces of all individual rods of the second plurality of rods are arranged in a first common plane for this second plurality of rods (different from the first common plane of the first plurality of rods). Similarly, the flat rod bottom surfaces of all individual rods of the third plurality of rods are arranged in a first common plane for this third plurality of rods (different from the first common plane of the first and second plurality of rods), and the flat rod bottom surface of all individual rods of the fourth plurality of rods are arranged in a first common plane for this fourth plurality of rods (different from the first common planes of the first, second and third plurality of rods).

This configuration allows for the measurement at different optical path lengths in the same volume of the liquid sample (i.e. in the same well). An advantage of the measurement at different optical path lengths in the same sample volume is that it allows the user to determine the most suitable optical path length for which the measured signal obeys best the correlation given by the Beer-Lambert law, and where a broad range of concentrations of a component in the sample can be covered. In addition, it allows to extend the measurement principle from only measuring the absorbance at one defined path length to contextualizing the individual measurements. For instance, the absorbance measurements at the individual path lengths can be contextualized by assessing the slope of the obtained absorbance values as a function of the optical path length.

According to a further aspect of the kit according to the invention, the plurality of threaded adjustment bolts consists of three threaded adjustment bolts arranged at the corners of a triangle, preferably of an isosceles triangle.

A triangular arrangement of three threaded adjustment bolts for determining the distance between upper plate and the lower plate allows for an adjustment of the respective distance at three distinct locations on the respective plate (those locations where the adjustment bolts are arranged). The adjustment of the respective distance at the location of one of the three threaded adjustment bolts allows the adjustment of the tilt of the upper plate with respect to the lower plate around an axis defined by a line through the respective locations of the respective other two adjustment bolts. Thus, the triangular arrangement of the three threaded adjustment bolts allows to control the distance and the tilt of the upper plate with respect to the lower plate, and thus enables an arrangement of the flat rod bottom surfaces parallel to the flat well bottom surfaces, as well as their arrangement at a predetermined distance from each other, without any overdetermination. Particularly advantageous may be an arrangement of the three threaded adjustment bolts on the corners of an isosceles triangle. This geometrical arrangement of the three threaded adjustment bolts provides for a high degree of stability and allows the adjustment of the tilt about a first axis corresponding to the base of the triangle and about two more axes at symmetrical angles relative to the first axis (corresponding to the legs of the triangle). Particularly advantageous is a triangular arrangement of the threaded adjustment bolts such that the base of the isosceles triangle extends parallel to a long lateral edge of the respective plate and the apex of the isosceles triangle is arranged midway of the long lateral edge of the respective plate. Ideally, the threaded adjustment bolts are arranged such that the base of the isosceles triangle is arranged as closely as possible to the long lateral edge of the respective plate and the base corners of the triangle are arranged as closely as possible to ends of the long lateral edge, while the apex is arranged as closely as possible to the opposite long lateral edge of the respective plate and midway of that opposite long lateral edge. Such an arrangement may allow for a high accuracy in the adjustment and control of the tilt angles of the upper plate relative to the lower plate and of the distance between the flat rod bottom surfaces and the flat well bottom surfaces.

According to a further aspect of the kit according to the invention, the rod pattern of each individual plurality of rods (regardless of whether only one plurality of rods or two or more, in particular four, pluralities of rods are present) is a same rectangular matrix having 96 locations, where the rods of each individual plurality of rods are arranged.

The locations of the matrix are arranged along 8 rows and 12 columns,
wherein a first threaded adjustment bolt and a second threaded adjustment bolt of the three threaded adjustment bolts are both arranged between a lowermost row and a second lowermost row of the rectangular matrix,
and wherein a third threaded adjustment bolt of the three threaded adjustment bolts is arranged between an uppermost row and a second uppermost row of the rectangular matrix. The first threaded adjustment bolt is arranged between an outermost left column and second outermost left column of the rectangular matrix, and the second threaded adjustment bolt is arranged between an outermost right column and a second outermost right column of the rectangular matrix.

The third threaded adjustment bolt is arranged between the two centermost columns of the rectangular matrix.

The arrangement of each individual plurality of rods in a same rectangular matrix having 96 locations wherein the locations of the matrix are arranged along 8 rows and 12 columns has the advantage that such an arrangement corresponds to that of a standard microplate, allowing to use standard equipment for the liquid sample handling and the microplate handling.

The arrangement of the three threaded adjustment bolts between the said rows and columns ensures that the respective distances between the threaded adjustment bolts are as large as possible without arranging the adjustment bolts outside of the matrix. Maximizing the respective distances of the threaded adjustment bolts increases the accuracy for the adjustment of the tilt of the upper plate with respect to the lower plate as well as the accuracy of the adjustment of the distance between the rod bottom surfaces and the well bottom surfaces.

According to another aspect of the kit according to the invention, the one end of the respective threaded adjustment bolt protruding from the upper plate or the lower plate, respectively, comprises a convex end surface.

A convex end surface at the one end of the respective threaded adjustment bolt protruding from the upper plate or the lower plate provides in essence a single point of contact of the one end of the threaded adjustment bolt with the respective other plate when the upper plate and the lower plate are assembled to form the microplate assembly. In contrast, in case the one end of the respective threaded adjustment bolt was to comprise for example a flat surface instead, the contact area of the said flat surface and the respective other plate would be either the whole said flat surface, an edge of the said flat surface or a point on this edge. This may cause unexpected nonlinearities or abrupt changes in the relation between the distance between the upper and the lower plate and the rotation of the threaded adjustment bolt. Moreover, the reference axis of the tilt of the upper plate with respect to the lower plate may not be unambiguously defined. Furthermore, in case the respective plate is made of glass at least in the area where the convex end of the threaded adjustment bolts makes contact with the respective plate, scratches and damages to the glass may be avoided by a sufficiently smooth convex end surface.

According to a further aspect of the kit according to invention, the alignment guides comprise
a first flange extending downwardly from the upper plate at a first lateral end of the upper plate and comprising a first flange alignment surface,
a second flange extending downwardly from the upper plate at a second lateral end of the upper plate opposite to the first lateral end and comprising a second flange alignment surface,
a first groove formed at a corresponding first lateral end of the lower plate and comprising a corresponding first groove alignment surface,
a second groove formed at a corresponding second lateral end of the lower plate and comprising a corresponding second groove alignment surface.

Each of the first and second flange alignment surfaces and the corresponding one of the first and second groove alignment surfaces are shaped and arranged to engage one another upon assembling the upper plate and the lower plate to form the microplate assembly.

The alignment guides ensure that the upper plate is accurately aligned with the lower plate when the upper plate and the lower plate are assembled to form the microplate assembly. In this regard, the ‘corresponding’ first lateral end and the ‘corresponding’ second lateral end of the lower plate, respectively, denotes the respective lateral end of the lower plate which is arranged on the same side as the downwardly extending first flange and second flange of the upper plate. The first and second alignment flanges and the first and second alignment grooves comprising the respective first and second flange alignment surfaces and first and second groove alignment surface are typically formed such that they allow the user to simply and accurately align the upper and lower plate with each other when assembling the upper and lower plate. In particular, substantially vertical first and second flange alignment surfaces and first and second groove alignment surfaces ensure that upper plate and the lower plate are aligned horizontally upon engagement of the corresponding first and second flange alignment surfaces and the first and second groove alignment surfaces.

In addition, the alignment guides do not only serve as a guide and alignment tool during assembly of the upper plate and the lower plate, but also keep the upper plate in its designated horizontal position with respect to the lower plate. The arrangement of the alignment flanges and corresponding grooves at opposite lateral ends of the respective plate are easily viewable during the assembly routine. This is advantageous compared to an alignment means that is ‘hidden’ during the assembly routine. Furthermore, such an arrangement of alignment flanges and grooves at opposite lateral ends of the respective plate ensures that the upper plate is stabilized with respect to the lower plate against movement in a direction other than towards and away from the lower plate.

According to another aspect of the kit according to the invention, the alignment guides further comprise
a third flange extending upwardly from the lower plate at a third lateral end of the lower plate and comprising a third flange alignment surface, the third lateral end of the lower plate being different from the first and second lateral ends of the lower plate,
a fourth flange extending upwardly from the lower plate at a fourth lateral of the lower plate opposite to the third lateral end and comprising a fourth flange alignment surface,
a third groove formed at a corresponding third lateral end of the upper plate and comprising a corresponding third groove alignment surface,
a fourth groove formed at a corresponding fourth lateral end of the upper plate and comprising a corresponding fourth groove alignment surface.

Each of the third and fourth flange alignment surfaces and the corresponding one of the third and fourth groove alignment surfaces are shaped and arranged to engage one another upon assembling the upper plate and the lower plate to form the microplate assembly.

Again, the ‘corresponding’ third lateral end and the ‘corresponding’ fourth lateral end of the upper plate, respectively, denotes the respective lateral end of the upper plate which is arranged on the same side as the upwardly extending third flange and fourth flange of the lower plate. The arrangement of the third and fourth groove at lateral ends different from the first and second lateral end further enhances the stability of the microplate assembly, further preventing any movement of the upper plate with relative to the lower plate other than towards and away from the lower plate.

According to a further aspect of the kit according to the invention,
the first flange alignment surface comprises an inwardly facing inner alignment surface and two laterally outwardly facing lateral alignment surfaces, the inner alignment surface comprising at least one bulge protruding inwardly away from the inner alignment surface,
the first groove alignment surface comprises an outwardly facing outer alignment surface and two laterally inwardly facing lateral alignment surfaces, the outer alignment surface comprising at least one inwardly recessed notch corresponding to the at least one bulge,
the second flange alignment surface comprises an inwardly facing inner alignment surface and two laterally outwardly facing lateral alignment surfaces, the inner alignment surface comprising at least one bulge protruding inwardly away from the second inner flange alignment surface, preferably two such bulges, and
the second groove alignment surface comprises an outwardly facing outer alignment surface and two laterally inwardly facing lateral alignment surfaces, the outer alignment surface comprising at least one inwardly recessed notch corresponding to the at least one bulge, preferably two such notches corresponding to the two such bulges,
   wherein each of the bulges and the corresponding one of the notches are arranged and shaped to engage one another upon assembling the upper plate and the lower plate to form the microplate assembly.

The inwardly facing inner alignment surfaces and their corresponding outwardly facing outer alignment surface align and stabilize the upper plate with respect to the lower plate mainly in a direction normal to the said surfaces when assembling the upper plate and the lower plate to form the microplate assembly. In addition to the alignment and stabilization provided by the inner and outer alignment surfaces, the lateral alignment surfaces support the alignment and the stabilization of the upper plate in directions other than the direction normal to the inner and the outer alignment surfaces. Similar lateral alignment surfaces may be provided to the third and fourth flange alignment surfaces and their corresponding grove alignment surfaces as well, for further stabilization and alignment support of the microplate assembly. The bulges and their corresponding notches further enhance the stability, in particular in directions other than the direction normal to the respective inner and outer alignment surfaces. Besides stabilization, the bulges and notches may help to define the orientation of the upper plate with respect to the lower plate to prevent any accidental assembly of the upper plate with the lower plate in an unwanted orientation. One way to define the orientation of the upper plate with respect to the lower plate by means of the bulges and the corresponding notches may be by providing one bulge to the first flange alignment surface and one corresponding notch to the first groove alignment surface and two bulges on the second flange alignment surface and two corresponding notches to the second groove alignment surface. Such arrangements of the bulges and notches do not only physically prevent a wrong assembly of the upper plate with the lower plate, they also provide an evident visual guide for the correct assembly of the upper plate with the lower plate.

According to still a further aspect of the kit according to the invention, the upper plate comprises a carrier plate made of a corrosion-resistant metal and comprising a plurality of through-holes arranged in the rod pattern, and wherein each individual rod of the same individual plurality of rods is fixed in a different individual through-hole of the plurality of through-holes.

The carrier plate made of a corrosion-resistant metal with the glass rods attached thereto allows for making use of the advantageous optical properties of glass on one hand, while at the same time allowing for a reliable and robust handling of the upper plate as a whole (carrier plate with glass rods fixed in the through-holes). In addition, both, the glass rods and the carrier plate made of the corrosion-resistant metal with through-holes can be simply and reliably manufactured, and due to their resistance to corrosion they can be cleaned and re-used.

In case there is only one plurality of rods, one individual rod of this single plurality of rods is fixed in each individual through-hole of the carrier plate. In case there are two or more pluralities of rods, one rod of each plurality of rods is fixed in each individual through hole of the carrier plate. In particular, in the above-discussed case of four pluralities of rods one rod of each of the four pluralities of rods is arranged in each individual through-hole of the carrier plate.

According to a further aspect of the kit according to the invention, each individual rod of the same plurality of rods is fixed in the respective different individual through-hole by adhesive.

Fixing each individual rod in the through-hole using adhesive is a simple and reliable way of attaching the rods to the carrier plate. No additional features, e.g. threads, are necessary that might complicate the manufacture of the said components.

According to another aspect of the kit according to the invention, the lower plate comprises a glass plate comprising the plurality of wells arranged in the well-pattern. The lower plate further comprises a frame made of a corrosion-resistant metal and accommodating the glass plate. The threaded adjustment bolts protrude from the upper plate and are arranged such that the ends thereof abut against the glass plate when the upper plate is assembled with the lower plate to form the microplate assembly.

This aspect has the advantage that such a glass plate comprising the wells is easy to manufacture with a high degree of precision. As glass is known to be a rather fragile material, the frame made of corrosion-resistant metal accommodating the glass plate ensures that the lower plate as a whole (i.e. frame with accommodated glass plate) is robust and is thus easy to handle.

Arranging the threaded adjustment bolts protruding from the upper plate such that the ends thereof abut against glass plate when the upper plate is assembled with the lower plate ensures that the distance between the upper plate can actually be adjusted accurately with the adjustment bolts. The threaded adjustment bolts abutting against the glass plate make sure that the distance between the flat rod bottom surfaces and the flat well bottom surfaces is precisely adjusted, since the flat well bottom surfaces are part of the glass plate and not of the metal frame.

According to a further aspect of the kit according to the invention, both the rods and the wells are cylindrical with a circular cross-section.

Cylindrical (glass) rods having a circular cross-section are easy to manufacture and are suitable for guiding a light beam that in many cases has a cross-sectional beam profile that is circular, too.

As already mentioned, according to a further aspect of the kit according to the invention the outer dimensions of both the lower plate and the upper plate are in conformance with the outer dimensions of the standard ANSI SLAS 1-2004 (R2012) for microplates. In this case the kit according to the invention offers the possibility to perform automated measurements using standard equipment, i.e. standard liquid handling equipment (e.g. standard multi-channel pipettes), standard plate handling equipment, and standard plate readers.

According to the invention, there is also suggested a microplate assembly for absorbance measurements of liquid samples, the microplate assembly being formed by the assembled upper plate and lower plate of the kit according to the invention, as it has been described above.

The components and advantages of the microplate assembly are already described above with respect to the kit for forming the microplate assembly, so that they are not repeated here.

When the upper plate and the lower plate are assembled to form the microplate assembly, the parallel arrangement of the flat rod bottom surface and flat rod well surfaces and the distance between them may be adjusted by the plurality of threaded adjustment bolts to compensate for any minor deviations from the ideal geometry of the upper and the lower plate which may have their origin in the manufacturing process or in temperature variations. The spacers comprising the threaded adjustment bolts may preferably be adjusted only once using a set of calibration measurements. For the calibration measurements, the wells may be filled with a reference liquid sample with a precisely known concentration and molar absorption coefficient of a component. The actual optical path lengths and any deviations from the expected optical path lengths can be calculated from the measurement of the absorbance using the equation defined by the Beer-Lambert law (see further above). The distance between the upper plate and the lower plate (and thus the distance of the rod bottom surfaces and the well bottom surfaces) may subsequently be adjusted such that the deviations of the actual optical path lengths and the expected optical path lengths are reduced. This calibration procedure may be iterated until the said deviations are reduced to a sufficiently small level. Any remaining deviations may be compensated during subsequent processing of the measurement data.

### BRIEF DESCRIPTION OF THE DRAWINGS

Further advantageous aspects of the invention become apparent from the following description of embodiments of the invention with the aid of the schematic drawings, in which:

FIG. 1 shows a first embodiment of the kit according to the invention, with all components of the kit shown in a perspective exploded view;

FIG. 2 shows the embodiment of the kit of FIG. 1 in a perspective view, with the components of each of the upper plate and the lower plate of the kit being assembled;

FIG. 3 shows a bottom view of the upper plate of the embodiment of the kit shown in FIG. 2;

FIG. 4 shows a top view of the lower plate of the embodiment of the kit shown in FIG. 2;

FIG. 5 shows a perspective view of an embodiment of a microplate assembly according to the invention, formed by the assembled upper plate and lower plate shown in FIG. 2;

FIG. 6 shows a sectional view along line VI-VI of the microplate assembly shown in FIG. 5;

FIG. 7 shows an enlarged view of the detail VII of FIG. 6;

FIGS. 8-9 show sectional views of the kit and the microplate assembly along line VIII-VIII of FIG. 5 with liquid sample contained in the wells, with FIG. 8 showing the the upper plate and the lower plate of the kit separated prior to being assembled, and with FIG. 9 showing the microplate assembly with the upper plate assembled to the lower plate;

FIGS. 10-11 show the same sectional views as FIGS. 8-9, however, with a smaller volume of liquid sample being contained in the wells;

FIG. 12 shows a bottom view of the upper plate of a second embodiment of the kit according to the invention; and

FIG. 13 shows a side view of the upper plate shown in FIG. 12.

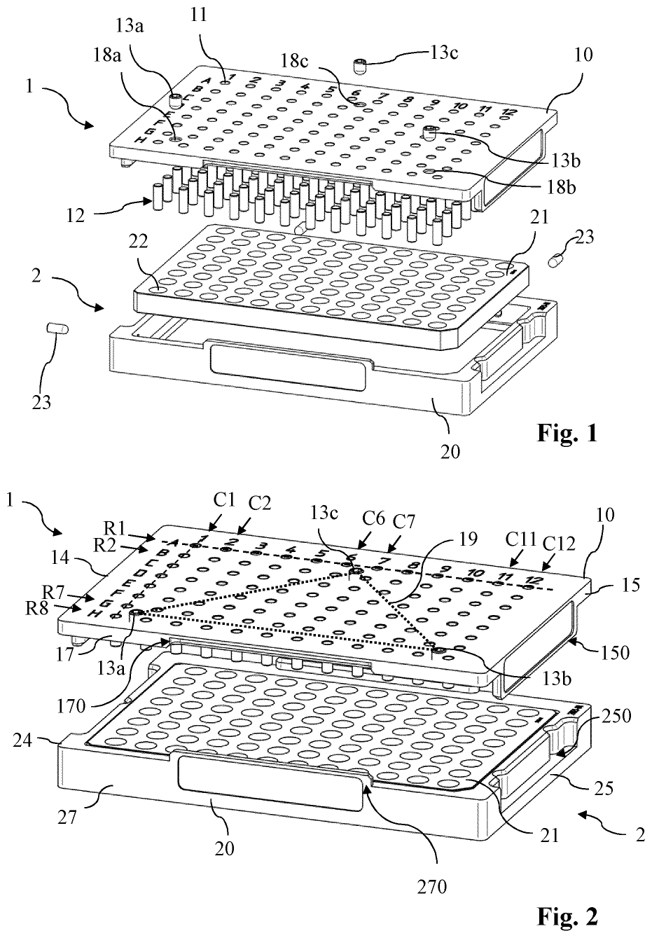

In FIG. 1, an exploded view of a first embodiment of the kit according to the invention is shown. The kit generally comprises an upper plate 1 and a lower plate 2. The upper plate 1 comprises a plurality of cylindrical rods 12 made of glass and having a circular cross-section. The rods 12 are arranged in a rod pattern (in the first embodiment a rectangular matrix of eight rows and twelve columns defining ninety-six different locations within the matrix, as will be discussed further below). The lower plate 2 comprises a metal frame 20 and a glass plate 21 comprising a plurality of cylindrical wells 22 with a circular cross-section arranged in a well pattern that corresponds to the rod pattern (a corresponding matrix of eight rows and twelve columns). In the first embodiment, only one plurality of rods 12 is provided (i.e. a single plurality of rods).

The upper plate 1 comprises a carrier plate 10 made of a corrosion-resistant metal, for example (anodized) aluminum. The carrier plate 10 comprises a plurality of trough-holes 11 arranged at the ninety-six different locations of the matrix for accommodating the individual rods 12 so that the individual rods 12 of the said one plurality of rods are arranged in the rod pattern (rectangular matrix). The carrier plate 10 further comprises three threaded through-holes 18a, 18b, 18c. Three threaded adjustment bolts 13a, 13b, 13c are arranged in these threaded through-holes 18a, 18b, 18c, with a first threaded adjustment bolt 13a of the three adjustment bolts being arranged in through-hole 18a, a second threaded adjustment bolt 13b of the three threaded adjustment bolts being arranged in threaded through-hole 18b, and a third threaded adjustment bolt 13c of the three threaded adjustment bolts being arranged in through-hole 18c. The three threaded adjustment bolts 13a, 13b, 13c serve to adjust the distance of the upper plate 1 from the lower plate 2 (and thus the distance 43 between a respective flat rod bottom surface 121 of a respective individual rod 12 and a flat well bottom surface 221 of a corresponding well 22, see FIG. 9) relative to each other when the upper plate 1 is assembled with the lower plate 2 to form the microplate assembly.

The lower plate 2 comprises a frame 20 made of a corrosion-resistant metal, for example (anodized) aluminum. The frame 20 accommodates the glass plate 21. The glass plate 21 is fixed by three clamping screws 23 (only two of them being labelled in FIG. 1) extending through threaded holes in the metal frame 20, thereby clamping the glass plate 21 and holding it in a predetermined position in the metal frame 20.

FIG. 2 shows the first embodiment of the kit already shown in FIG. 1, however, with the components of each of the upper plate 1 and the lower plate 2 of the kit being assembled. That is to say, the rods 12 are fixed in the through-holes 11 of the carrier plate 10 (one individual rod 12 in each individual through-hole 11), and the threaded adjustment bolts 13a, 13b, 13c are arranged in the through-holes 18a, 18b, 18c to protrude downwardly from the thus formed upper plate 1. The glass plate 21 is inserted in the d in the metal frame 20 and is fixed in the metal frame with the aid of the clamping screws 23.

As already shortly mentioned above, in this first embodiment of the kit the rod pattern is a rectangular matrix having ninety-six different locations, wherein these ninety-six different locations of the matrix are arranged along eight rows R1-R8 (labelled by the letters A-H on the carrier plate 10 in FIG. 1 and FIG. 2) and along twelve columns C1-C12 (labelled by the numbers 1-12 on the carrier plate 10 in FIG. 1 and FIG. 2). The first and second threaded adjustment bolts 13a and 13b are arranged between the second lowermost row R7 and the lowermost row R8 of the rectangular matrix, with the first threaded adjustment bolt 13a being arranged between the outermost left column C1 and the second outermost left column C2 and with the second threaded adjustment bolt 13b being arranged between the second outermost right column C11 and the outermost right column C12. The third threaded adjustment bolt 13c is arranged between the uppermost row R1 and the second uppermost row R2 as well as between the centermost columns C6 and C7. Thus, the threaded adjustment bolts 13a, 13b, 13c form an isosceles triangle 19 (indicated by a dotted line in FIG. 2) wherein the corners of the said triangle 19 are arranged as far apart from one another as possible to ensure a high accuracy of the adjustment with the aid of the three threaded adjustment bolts 13a, 13b, 13c.

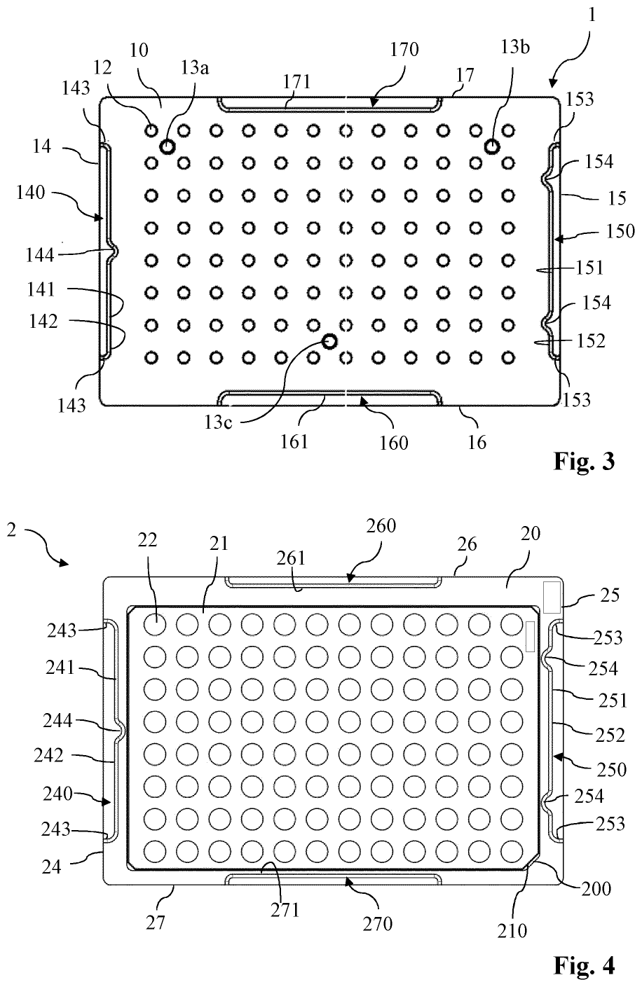

Alignment guides are provided at a first lateral end 14 and at a second lateral end 15 of the upper plate 1 opposite to the first lateral end 14, as well as at a corresponding first lateral end 24 and at a corresponding second lateral end 25 of the lower plate 2. The alignment guides serve to align the upper plate 1 and the lower plate 2 relative to each other upon assembling the upper plate 1 and the lower plate 2 to form the microplate assembly. In the first embodiment shown in FIG. 1 and FIG. 2, the alignment guides comprise a first flange 140 extending downwardly from the upper plate 1 at the first lateral end 14 thereof (see FIG. 3) and a second flange 150 extending downwardly from the upper plate 1 at the second lateral end 15 thereof. The alignment guides further comprise a first groove 240 formed at the corresponding first lateral end 24 of the lower plate 2 and a second groove 250 formed at the corresponding second lateral end 25 of the lower plate 2 (see FIG. 4).

The geometrical shape of the first and second flanges 140,150, as well as the geometrical shape of the first and second grooves 240, 250 can also be seen in FIG. 3 and FIG. 4. FIG. 3 shows a bottom view of the (assembled) upper plate 1 and FIG. 4 shows a top view of the (assembled) lower plate 2 of FIG. 2.

In FIG. 3, the first lateral end 14 of the upper plate 1 is shown to be on the left side of the upper plate 1. The first flange 140 comprises a first flange alignment surface 141 that extends downwardly from the upper plate 1 (i.e. out of the drawing plane towards the reader). The first flange alignment surface 141 comprises an inwardly facing inner alignment surface 142 and two laterally outwardly facing lateral alignment surfaces 143. The said alignment surfaces 141,142, 143 are embodied as essentially vertical flat walls which are connected to one another via rounded edges. In addition, the inner alignment surface 142 comprises a bulge 144 protruding inwardly away from the inner alignment surface 142.

The second lateral end 15 of the upper plate 1 is shown to be on the right side of upper plate 1. The second flange 150 comprises a second flange alignment surface 151 that comprises an inwardly facing inner alignment surface 152 and two laterally outwardly facing lateral alignment surfaces 153 mirroring their corresponding counterparts at the first lateral end 14 of the upper plate 1. The second inner flange alignment surface 152 comprises two bulges 154 protruding inwardly away from the inner alignment surface 152.

In analogy to FIG. 3, in FIG. 4 the first lateral end 24 of the lower plate 2 is shown to be on the left side of the lower plate 2, and the second lateral end 25 of the lower plate 2 is shown to be on the right side. The first groove 240 comprises a first groove alignment surface 241 formed at the first lateral end 24. The first groove alignment surface 241 comprises an outwardly facing outer alignment surface 242 and two laterally inwardly facing lateral alignment surfaces 243. In addition, the outer alignment surface 242 further comprises an inwardly recessed notch 244 corresponding to the bulge 144 of the upper plate 1.

Similarly, the second groove 250 arranged at the second lateral end 25 of the lower plate 2 comprises a second groove alignment surface 251. The second groove alignment surface 251 comprises an outwardly facing outer alignment surface 252 and two laterally inwardly facing lateral alignment surfaces 253 mirroring their corresponding counterparts at the first lateral end 24 of the lower plate 2. The second inner groove alignment surface 252 comprises two inwardly recessed notches 254 corresponding to the two bulges 154 of the upper plate 1.

The shape of all alignment surfaces 241, 242, 243 of the first groove 240 at the first lateral end 24 of the lower plate 2 including the notch 244 match the shape of the corresponding alignment surfaces 141, 142, 143 of the first flange 140 of the upper plate 1 including the bulge 144. This holds similarly for the alignment surfaces 251, 252, 253 of the second groove 250 at the second lateral end 25 of the lower plate 2 including the notches 245 that match the shape of the corresponding alignment surfaces 151, 152, 153 of the second flange 150 of the upper plate 1 including the two bulges 154. When the upper plate 1 is assembled with the lower plate 2, the respective inner and outer alignment surfaces 142, 152, 242, 252 of the upper plate 1 and lower plate 2 ensure that the upper plate 1 is correctly aligned with the lower plate 2 in a longitudinal direction (the horizontal direction in the drawing plane). The respective lateral alignment surfaces 143, 153, 243, 253 ensure that the upper plate is correctly aligned with the lower plate in a transversal direction (the vertical direction in the drawing plane). The bulges 144 and 154 and the notches 244 and 254 do not only further support the alignment and the stability, but also make sure that the upper plate 1 is assembled in the correct orientation with the lower plate 2.

As is further shown in FIG. 4, the alignment guides further comprise a third flange 260 extending upwardly from a third lateral end 26 of the lower plate 2 and a fourth flange 270 extending upwardly from a fourth lateral end 27 opposite to the third lateral end 26 of the lower plate 2. The alignment guides further comprise a corresponding third groove 160 provided at a corresponding third lateral end 16 of the upper plate 1 as well as a corresponding fourth groove 170 provided at a corresponding fourth lateral end 17 of the upper plate 1 are shown in FIG. 3. The third flange 260 and the fourth flange 270 and the corresponding third and fourth grooves 160 and 170 further support the alignment procedure and the stability of the microplate assembly.

Furthermore, FIG. 4 shows the glass plate 21 assembled with the aluminum frame 20. The correct orientation of the glass plate 21 in the aluminum frame 20 is ensured by a chamfered edge 210 on the glass plate 21 and a corresponding chamfered edge 200 on the aluminum frame 20.

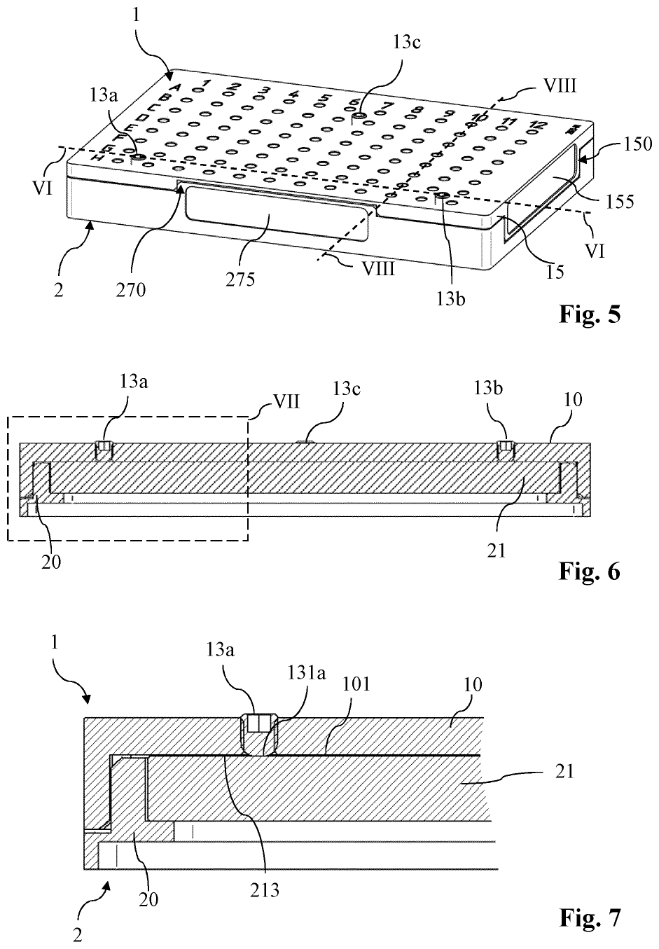

FIG. 5 shows a perspective view of an embodiment of the microplate assembly according to the invention formed by the assembled upper plate 1 and lower plate 2 of the kit described above. As can be seen in FIG. 5, the various alignment flanges and grooves of the upper plate 1 and the lower plate 2 are engaged with each other. As can further be seen in FIG. 5, the flanges further comprise outwardly facing recessed surfaces of which only the recessed surface 155 of the second flange 150 arranged at the second end 15 of the upper plate 1 and the recessed surface 275 of the fourth flange 270 are visible in FIG. 5. Corresponding recessed surfaces (not visible in FIG. 5) are also provided in the first flange 140 of the upper plate 1 and in the third flange 260 of the lower plate 2. The recessed surfaces are of rectangular shape and are recessed inwardly by e.g. 0.5 mm. They serve as gripping/contact surfaces for corresponding standard equipment for a fully automated handling of the upper plate 1 and the lower plate 2 or of the microplate assembly formed thereof. The outer dimensions are preferably in conformance with the outer dimensions of the standard ANSI SLAS 1-2004 (R2012) for microplates specifying a length of 127.76 mm+/−0.5 mm and a width of 85.48 mm+/−0.5 mm.

When the upper plate 1 is assembled with the lower plate 2 to form the microplate assembly, the upper plate 1 rests on the lower plate 2 only via the end surfaces of the three threaded adjustment bolts 13a, 13b, 13c. By adjusting the threaded adjustment bolts 13a, 13b, 13c, the distance between the upper plate 1 and the lower plate 2 can be adjusted at the position of each threaded adjustment bolt 13a, 13b, 13c. This allows for the adjustment of both, the (parallel) distance between the upper plate 1 and the lower plate 2 but also the tilt of the upper plate 1 relative to the lower plate 2.

FIG. 6 shows a sectional view of the microplate assembly along line VI-VI in FIG. 5. The first threaded adjustment bolt 13a and the second threaded adjustment bolt 13b are arranged in the two respective threaded through holes 18a, 18b of the carrier plate 10 (see FIG. 1). FIG. 7 shows an enlarged view of the detail VII of FIG. 6. It can be seen, that the first threaded adjustment bolt 13a has an end 131a that has a convex end surface resting on an upper surface 213 of the glass plate 21 of the lower plate 2. The carrier plate 10 itself does not rest with a lower surface 101 thereof on the upper surface 213 of the glass plate 21, but rather there is a small gap between the upper surface 213 of the glass plate 21 and the lower surface 101 of the carrier plate 10, so that the upper plate 1 as a whole rests on the lower plate 2 as a whole only at those points where the convex end surfaces of the three threaded adjustment bolts 13a, 13b, 13c make contact with the upper surface 213 of the glass plate 21.

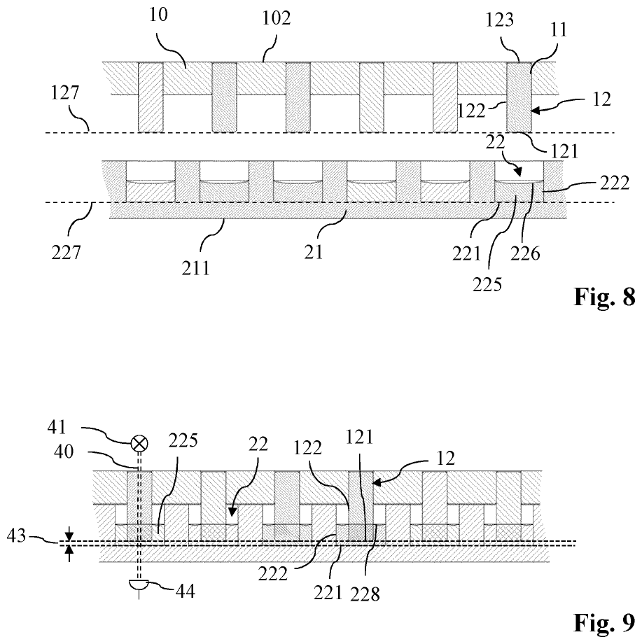

FIG. 8 and FIG. 9 show sectional views of the upper plate 1 and the lower plate 2 along line VIII-VIII of FIG. 5 of the kit or of the microplate assembly, respectively. In FIG. 8, the upper plate 1 and the lower plate 2 are separated (kit), and in FIG. 9 the upper plate 1 is assembled with the lower plate 2 (microplate assembly).

As can further be seen there, the rods 12 made of glass comprise a flat rod bottom surface 121 and a lateral outer rod surface 122 extending upwards from a perimeter of the flat rod bottom surface 121. The rods 12 are cylindrical rods with a circular cross section. In this embodiment, the flat rod bottom surface 121 is a circular surface having a diameter of 3 mm, and the lateral outer rod surface 122 is shaped as a circular outer cylinder surface. For the volumes of the liquid sample typically used in such applications, the diameter of the circular flat rod bottom surface 121 may be as small as 0.5 mm. The flat rod bottom surfaces 121 are all arranged in a common first plane 127. The glass the rods 12 are made of is preferably quartz glass. The flat rod bottom surface 121 and a flat top surface 123 of each rod 12 are polished and may have a surface roughness Rₐ=0.3 or smaller.

As can be seen, the top surfaces 123 of the rods 12 are arranged in the through-holes 11 such that the top surfaces 123 are slightly recessed relative to an upper surface 102 of the carrier plate 10 in order avoid scratches in the top surfaces 123 of the rods 12. Each rod 12 is fixed in its respective through-hole 11 by adhesive. To ensure that all flat rod bottom surfaces 121 are arranged in the common first plane 127, the rods 12 may be fixed in the respective through-holes 11 with the help of a corresponding spacer (not shown), preferably made of plastic, defining the small distance between the upper rod surface 123 and the upper surface 102 of the carrier plate 10 (slightly recessed arrangement).

The wells 22 of the glass plate 21 are cylindrical as well and comprise a flat well bottom surface 221 which is shaped as a circular surface having a diameter of 6 mm. However, for very small volumes of the liquid sample, the diameter of the circular flat well bottom surface 221 may be as small as 1 mm. The area of the flat well bottom surface generally ranges from 0.7 mm² to 29 mm². Each cylindrical well 22 of the glass plate 21 further comprises a lateral inner well surface 222 shaped as an inner cylinder surface. The flat well bottom surfaces 221 are arranged in a common second plane 227. The flat well bottom surface 221 of each well 22 is polished and may have a surface roughness Rₐ=0.3 or smaller. Similarly, a bottom surface 211 of the glass plate 21 is either entirely polished to the same surface roughness Rₐ, or is polished to the same surface roughness at least in those regions of the bottom surface 211 that are traversed by a light beam 40 for the absorbance measurement.

As can be seen further, the wells 22 are partially filled with a liquid sample 225. Due to cohesive forces within the liquid sample and adhesive forces between the liquid sample and the lateral inner surfaces 222 of the wells 22, a meniscus 226 is formed at the surface of the liquid sample 225. The concave meniscus 226 shown is formed when the adhesive forces are stronger than the cohesive forces, as this is typically the case for aqueous solutions. When the upper plate 1 and the lower plate 2 are assembled to form the microplate assembly, the rods 12 are lowered into the wells 22 and are immersed in the liquid sample 225, with the distance between the flat rod bottom surfaces 121 and the flat well bottom surfaces 221 being defined by the three threaded adjustment bolts 13a, 13b, 13c.

In FIG. 9 a light beam 40 emitted from a light source 41 traverses a rod 12 and a liquid sample 225 contained in the well 22 on the way from the light source 41 to a detector 44, for measuring the (spectrally resolved) transmission of the light through the liquid sample (from which the absorbance of the liquid sample can be calculated). The optical path length of the light through the liquid sample corresponds to the distance 43 between the flat rod bottom surface 121 and the flat well bottom surface 221, and ranges from 0.05 mm to 5 mm, in particular from 0.1 mm to 2 mm, especially from 0.2 mm to 1 mm. This distance between flat rod bottom surface 121 and the flat well bottom surface 221 and thus the optical path length through the liquid sample is constant over the whole cross section of the light beam 40 since the flat rod bottom surface 121 of each rod 12 is arranged parallel to the flat well bottom surface 221 of each well 22. The small meniscus 228 formed between the lateral inner well surface 222 of the well 22 and the lateral outer rod surface 122 of the rod 12 is not traversed by the light beam 40 and, therefore, this meniscus 228 does not have any influence on the transmission/absorbance measurement. Even in case the volume of the liquid sample 225 and thus the filling level of the liquid sample 225 may be affected to a minor extent by evaporation, the optical path length is not affected. However, as already mentioned above, evaporation is either completely avoided or at least greatly reduced as each liquid sample 225 is essentially enclosed by the lateral inner well surfaces 221 and by the carrier plate 10.

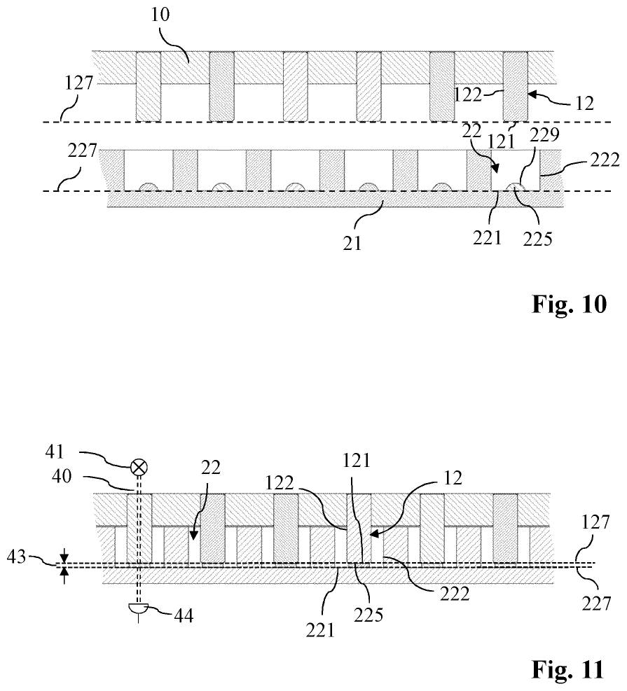

In FIG. 10 and FIG. 11 the same sectional views are shown as FIGS. 8 and 9, however, with a significantly smaller amount of the liquid sample 225 being contained in the wells 22. Here, only a drop of the liquid sample 225 is dispensed into each well 22 at the center of the respective well 22. The volume of the liquid sample 225 is so small that it does not wet the entire flat well bottom surface 221, so that a drop with a curved surface 229 is formed on the flat well bottom surface 221. Modern liquid handling equipment is capable of dispensing such small volumes of liquid sample 225 with high precision into each well and at the center of the respective well 22. As shown in FIG. 11, also in this situation, the optical path length is constant over the entire cross section of the light beam 40.

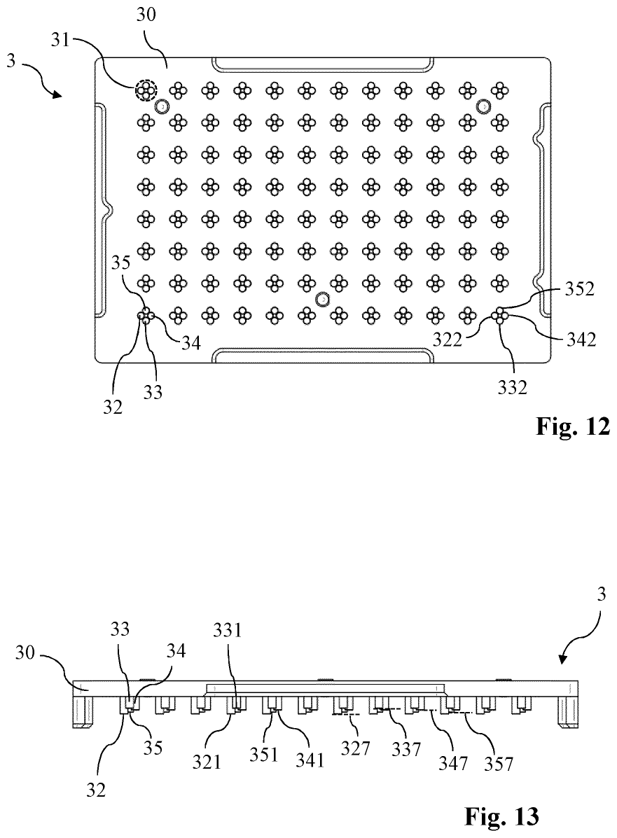

FIG. 12 and FIG. 13 show a bottom view and a side view, respectively, of an upper plate 3 of a second embodiment of the kit according to the invention. The lower plate of this second embodiment may be identical with the lower plate 2 of the first embodiment of the kit. In this second embodiment, the upper plate 3 comprises four pluralities of rods, with the individual rods 32, 33, 34, 35 of each plurality of the four pluralities having a diameter of 2 mm, for example. All rods of the same plurality or rods have the same length, but the length of the rods 32, 33, 34, 35 of different pluralities are different. One rod 32, 33, 34, 35 of each plurality of rods is arranged in each through-hole 31 provided in the carrier plate 30 (one of the through-holes being indicated by dashed lines in FIG. 12). The through-holes 31 are arranged in the carrier plate 30 in the same matrix arrangement as the rods 12 of the first embodiment of the kit, and the circular through-holes 31 have the same circular shape as in the first embodiment. Each rod 32, 33, 34, 35 of the four pluralities comprises a flat rod bottom surface 321, 331, 341, 351 and an outer rod surface 322, 332, 342, 352. Fixation of the four rods 32, 33, 34, 35 in each of the individual through-holes 31 of the carrier plate 30 is performed in the same manner as has been described for the first embodiment of the kit. This means, that once the four rods 32, 33, 34, 35 have been fixed in the through-holes 31 by adhesive, the flat rod bottom surfaces 321 of all rods 32 of this (e.g. first) plurality of rods are arranged in a first common plane 327. Similarly, the flat rod bottom surfaces 331 of all rods 33 of another (e.g. second) plurality of rods are arranged in another first common plane 337 different from the first common plane 327. Further, the flat rod bottom surfaces 341 of all rods 34 of still another (e.g. third) plurality of rods are arranged in still another first common plane 347 different from the first common planes 327, 337. And finally, the flat rod bottom surfaces 351 of all rods 35 of yet another (e.g. fourth) plurality of rods are arranged in yet another first common plane 357 different from the first common planes 327, 337, 347. On the other hand, the flat well bottom surfaces 22 of the glass plate 21 are all arranged in the same second common plane 227 (see first embodiment). As a consequence, the distances between the flat rod bottom surfaces 321, 331, 341, 351 and the flat well bottom surface 221 of the wells 22 of the glass plate 21 are different. As has been mentioned above already, this results in different optical path lengths in the same volume of the liquid sample (i.e. in the same well) being available and allows for transmission/absorbance measurements at four different optical path lengths. This allows the user to determine the most suitable optical path length for which the measured signal obeys best the correlation given by the Beer-Lambert law. The other features of the upper plate 3 of the second embodiment of the kit may be identical with those of the upper plate 1 of the first embodiment of the kit. Therefore, they are not discussed here again. As mentioned, the lower plate of the second embodiment of the kit (not shown in FIG. 12 and FIG. 13) may be identical with the lower plate 2 of the first embodiment of the kit.

Embodiment of the kit and the microplate assembly according to the invention are described above with the aid of the drawings. However, the invention is not limited to these embodiments, but rather many variations and modifications are possible without departing from the teaching underlying the invention. Therefore, the scope of protection is not limited to the embodiments, but rather is defined by the appended claims.

1. Kit for forming a microplate assembly for absorbance measurements of liquid samples, the kit comprising:
an upper plate (1, 3) comprising at least one plurality of downwardly protruding rods (12; 32, 33, 34, 35) made of glass and arranged in a rod pattern, each of the rods (12; 32, 33, 34, 35) comprising a flat rod bottom surface (121; 321, 331, 341, 351) facing downwards and a lateral outer rod surface (122; 322, 332, 342, 352) extending upwards from a perimeter of the flat rod bottom surface (121; 321, 331, 341, 351), wherein the flat rod bottom surfaces (121; 321, 331, 341, 351) of all rods (12; 32, 33, 34, 35) of a same individual plurality of rods are arranged in a respective common first plane (127; 327, 337, 347, 357), and wherein each individual plurality of rods (12;32, 33, 34, 35) comprises the same number of rods (12; 32, 33, 34, 35) and is arranged in the same rod pattern,
a lower plate (2),
alignment guides for aligning the upper plate (1, 3) and the lower plate (2) relative to each other upon assembling the upper plate (1, 3) and the lower plate (2) to form the microplate assembly, and
spacers for determining the distance of the upper plate (2) and the lower plate (2) relative to each other upon assembling the upper plate (1, 3) and the lower plate (2) to form the microplate assembly,
wherein
the lower plate (2) comprises a plurality of wells (22) made of glass, the number of wells (22) of the plurality of wells (22) corresponding to the number of rods (12; 32, 33, 34, 35) of each individual plurality of rods (12; 32, 33, 34, 35) and being arranged in a well pattern corresponding to the rod pattern,
wherein each of the wells (22) comprises a flat well bottom surface (221) facing upwards and having an area in the range of 0.7 mm² to 29 mm², the flat well bottom surfaces (221) of all wells (22) being arranged in a common second plane (227),
and wherein each of the wells (22) further comprises a lateral inner well surface (222) extending upwards from a perimeter of the flat well bottom surface (221), with the lateral inner well surface (222) being dimensioned to surround the lateral outer rod surface (122; 322, 332, 342, 352) when the upper plate (1, 3) and the lower plate (2) are assembled to form the microplate assembly (1, 3),
wherein
the alignment guides are configured and arranged such that when the upper plate (1, 3) is assembled with the lower plate (2) to form the microplate assembly, the alignment guides engage one another to align the upper plate (1, 3) and the lower plate (2) such that each well of the plurality of wells (22) accommodates one rod (12; 32, 33, 34, 35) of each individual plurality of rods (12; 32, 33, 34, 35),
and wherein
the spacers comprise a plurality of threaded adjustment bolts (13a, 13b, 13c),
wherein each threaded adjustment bolt (13a, 13b, 13c) of the plurality of threaded adjustment bolts is arranged in a threaded through-hole (18a, 18b, 18c) of the upper plate (1, 3) or the lower plate (2), with one end (131a) of the respective threaded adjustment bolt (13a, 13b, 13c) protruding from the upper plate (1, 3) or the lower plate (2), respectively,
such that when the upper plate (1, 3) is assembled with the lower plate (2) to form the microplate assembly, the one end (131a) of the respective threaded adjustment bolt (13a) abuts against the lower plate (2) or the upper plate (1, 3), respectively, and the flat rod bottom surface (121; 321, 331, 341, 351) of each rod (12; 32, 33, 34, 35) of each individual plurality of rods (12; 32, 33, 34, 35) is arranged parallel to the corresponding flat well bottom surface (221) and faces the flat well bottom surface (221) at a predetermined distance in the range of 0.05 mm to 5 mm, in particular 0.1 mm to 2 mm, especially 0.2 mm to 1 mm.

2. The kit according to claim 1, wherein the upper plate (1) comprises only one plurality of downwardly protruding rods (12).

3. The kit according to claim 1, wherein the upper plate (3) comprises two or more pluralities of downwardly protruding rods (32, 33, 34, 35), in particular four pluralities of downwardly protruding rods (32, 33, 34, 35), and wherein all rods (32, 33, 34, 35) of the same individual plurality of rods have the same length.

4. The kit according to any one of the preceding claims, wherein the plurality of threaded adjustment bolts consists of three threaded adjustment bolts (13a, 13b, 13c) arranged at the corners of a triangle (19), preferably of an isosceles triangle (19).

5. The kit according to claim 4, wherein the rod pattern of each individual plurality of rods (12; 32, 33, 34, 35) is a same rectangular matrix having ninety-six locations, where the rods (12; 32, 33, 34, 35) of each individual plurality of rods are arranged,
wherein the locations of the matrix are arranged along eight rows (R1-R8) and twelve columns (C1-C12),
wherein a first threaded adjustment bolt (13a) and a second threaded adjustment bolt (13b) of the three threaded adjustment bolts (13a, 13b, 13c) are both arranged between a lowermost row (R8) and a second lowermost row (R7) of the rectangular matrix,
wherein a third threaded adjustment bolt (13c) of the three threaded adjustment bolts (13) is arranged between an uppermost row (R1) and a second uppermost row (R2) of the rectangular matrix,
wherein the first threaded adjustment bolt (13a) is arranged between an outermost left column (C1) and second outermost left column (C2) of the rectangular matrix,
wherein the second threaded adjustment bolt (13b) is arranged between an outermost right column (C12) and a second outermost right column (C11) of the rectangular matrix,
and wherein the third threaded adjustment bolt (13c) is arranged between the two centermost (C6, C7) columns of the rectangular matrix.

6. The kit according to any one of the preceding claims, wherein the one end (131a) of the respective threaded adjustment bolt (13a) protruding from the upper plate (1, 3) or the lower plate (2), respectively, comprises a convex end surface.

7. The kit according to any one of the preceding claims, wherein the alignment guides comprise
a first flange (140) extending downwardly from the upper plate (1, 3) at a first lateral end (14) of the upper plate (1, 3) and comprising a first flange alignment surface (141),
a second flange (150) extending downwardly from the upper plate at a second lateral end (15) of the upper plate (1, 3) opposite to the first lateral end (14) and comprising a second flange alignment surface (151),
a first groove (240) formed at a corresponding first lateral end (24) of the lower plate (2) and comprising a corresponding first groove alignment surface (241),
a second groove (250) formed at a corresponding second lateral end (25) of the lower plate (2) and comprising a corresponding second groove alignment surface (251),
wherein each of the first (141) and second (151) flange alignment surfaces and the corresponding one of the first (241) and second (251) groove alignment surfaces are shaped and arranged to engage one another upon assembling the upper plate (1, 3) and the lower plate (2) to form the microplate assembly.

8. The kit according to claim 7, wherein the alignment guides further comprise
a third flange (260) extending upwardly from the lower plate (2) at a third lateral end (26) of the lower plate (2) and comprising a third flange alignment surface (261), the third lateral end (26) of the lower plate (2) being different from the first (24) and second lateral (25) ends of the lower plate (2),
a fourth flange (270) extending upwardly from the lower plate (2) at a fourth lateral end (27) of the lower plate (2) opposite to the third lateral end (26), and comprising a fourth flange alignment surface (271),
a third groove (160) formed at a corresponding third lateral end (16) of the upper plate (1) and comprising a corresponding third groove alignment surface (161),
a fourth groove (170) formed at a corresponding fourth lateral end (17) of the upper plate (1, 3) and comprising a corresponding fourth groove alignment surface (171),
wherein each of the third and fourth flange alignment surfaces (261, 271) and the corresponding one of the third and fourth groove alignment surfaces (161,171) are shaped and arranged to engage one another upon assembling the upper plate (1, 3) and the lower plate (2) to form the microplate assembly.

9. The kit according to any one of claims 7 and 8, wherein
the first flange alignment surface (141) comprises an inwardly facing inner alignment surface (142) and two laterally outwardly facing lateral alignment surfaces (143), the inner alignment surface (142) comprising at least one bulge (144) protruding inwardly away from the inner alignment surface (142),
the first groove alignment surface (241) comprises an outwardly facing outer alignment surface (242) and two laterally inwardly facing lateral alignment surfaces (243), the outer alignment surface (242) comprising at least one inwardly recessed notch (244) corresponding to the at least one bulge (144),
the second flange alignment surface (151) comprises an inwardly facing inner alignment surface (152) and two laterally outwardly facing lateral alignment surfaces (153), the inner alignment surface (152) comprising at least one bulge (154) protruding inwardly away from the second inner flange alignment surface (152), preferably two such bulges (154), and
the second groove alignment surface (251) comprises an outwardly facing outer alignment surface (252) and two laterally inwardly facing lateral alignment surfaces (253), the outer alignment surface (253) comprising at least one inwardly recessed notch (254) corresponding to the at least one bulge (154), preferably two such notches (254) corresponding to the two such bulges (154),
wherein each of the bulges (144, 154) and the corresponding one of the notches (244, 254) are arranged and shaped to engage one another upon assembling the upper plate (1) and the lower plate (2) to form the microplate assembly.

10. The kit according to any one of the preceding claims, wherein the upper plate (1) comprises a carrier plate (10) made of a corrosion-resistant metal and comprising a plurality of through-holes (11, 31) arranged in the rod pattern, and wherein each individual rod (12; 32, 33, 34, 35) of the same individual plurality of rods is fixed in a different individual through-hole (11, 31) of the plurality of through-holes.

11. The kit according to claim 10, wherein each individual rod (12; 32, 33, 34, 35) of the same individual plurality of rods is fixed in the respective different individual through-hole (11, 31) by adhesive.

12. The kit according to any one of the preceding claims, wherein the lower plate (2) comprises a glass plate (21) comprising the plurality of wells (22) arranged in the well-pattern, wherein the lower plate (2) further comprises a frame (20) made of a corrosion-resistant metal and accommodating the glass plate (21), and wherein the threaded adjustment bolts (13) protrude from the upper plate and are arranged such that the ends thereof abut against the glass plate (21) when the upper plate (1, 3) is assembled with the lower plate (2) to form the microplate assembly.

13. The kit according to any one of the preceding claims, wherein both the rods (12; 32, 33, 34, 35) and the wells (22) are cylindrical with a circular cross-section.

14. The kit according to any one of the preceding claims, wherein the outer dimensions of both the lower plate (2) and the upper plate (1, 3) are in conformance with the outer dimensions of the standard ANSI SLAS 1-2004 (R2012) for microplates.

15. Microplate assembly for absorbance measurements of liquid samples, the microplate assembly being formed by the assembled upper plate (1, 3) and lower plate (2) of the kit according to any one of the preceding claims.
